(19) United States
(12) Patent Application Publication
(10) Pub. No.: US 2026/0323740 A1
(43) Pub. Date: Oct. 15, 2026

(54) MECHANISMS TO SUPPORT LONG RANGE DISCOVERY IN WI-FI SYSTEMS

(71) Applicant: InterDigital Patent Holdings, Inc., Wilmington, DE (US)

(72) Inventors: Hanqing Lou, Syosset, NY (US); Xiaofei Wang, North Caldwell, NJ (US); Ying Wang, Easton, PA (US); Mahmoud Saad, Montreal (CA); Rui Yang, Greenlawn, NY (US)

(73) Assignee: InterDigital Patent Holdings, Inc., Wilmington, DE (US)

(21) Appl. No.: 19/176,974

(22) Filed: Apr. 11, 2025

(51) Int. Cl. H04W 76/15; H04W 76/25

(52) U.S. Cl. CPC H04W 76/15; H04W 76/25

(57) ABSTRACT

A discovery procedure example with long range multi-link devices (MLDs) includes an access point (AP) MLD and a non-AP station (STA) MLD using a first link and second link. A first non-AP STA is affiliated with the non-AP STA MLD, and a first AP STA is affiliated with the AP MLD. The first non-AP STA receives a first beacon over the first link, and transmits, based on the first beacon, over the first link, a multi-link (ML) probe request frame including and a request for a profile of a second AP STA affiliated with the AP MLD. The first non-AP STA receives, responsive to the ML probe request frame, over the first link, an ML probe response frame including the profile. The first non-AP STA transmits a report, including a measurement of the first link or the second link.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

The traffic between STAs within a BSS may be considered as or referred to as peer-to-peer traffic. The peer-to-peer traffic may be sent between, for example, directly between, the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP; and the STAs, for example, all of the STAs, within or using the IBSS may communicate directly with each other. The IBSS mode of communication may sometimes be referred to herein as an “ad-hoc” mode of communication.

Using the 802.11ac infrastructure mode of operation, the AP may transmit a beacon on a fixed channel, usually the primary channel. This channel may be 20 megahertz (MHz) wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit any given time, frequency, and space resources in each BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining 8 contiguous 20 MHz channels, or by combining two non-contiguous 80 MHz channels, which may also be referred to as an 80+80 configuration.

For an 80+80 configuration, at the transmitter, the data, after channel encoding, is passed through a segment parser that divides it into two streams. The Inverse Fast Fourier Transformation (IFFT) operation and time-domain processing is done on each stream separately. The streams are then mapped on to the two channels, and the data is transmitted. At the receiver, this mechanism is reversed, and the combined data is sent to the medium access control (MAC) layer.

Sub 1 GHz modes of operation are supported by 802.11af, and 802.11ah. For these specifications the channel operating bandwidths, and carriers, are reduced relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

### SUMMARY

Mechanisms are provided herein of a discovery procedure with long range multi-link devices (MLDs). In an example, an access point (AP) MLD and a non-AP station (STA) MLD may use a first link and a second link. A first non-AP STA is affiliated with the non-AP STA MLD, and a first AP STA is affiliated with the AP MLD. The first AP STA transmits, and the first non-AP STA receives, a first beacon over the first link.

Further, the first non-AP STA transmits, based on the first beacon, over the first link, an multi-link (ML) probe request frame including a request for a profile of a second AP STA affiliated with the AP MLD. Additionally or alternatively, the ML probe request frame further includes an ML element. The ML probe request is transmitted to, and received by, the first AP STA. Also, the first non-AP STA receives, responsive to the ML probe request frame, over the first link, an ML probe response frame including the profile of the second AP STA. The ML probe response frame is received from, and transmitted by, the first AP STA.

Moreover, the first non-AP STA transmits, over the first link, a report, including at least one measurement of at least one of the first link or the second link. Additionally or alternatively, the first non-AP STA transmits long range report based on the ML probe response frame. Additionally or alternatively, the report includes an ML report. Additionally or alternatively, the ML report includes the at least one measurement of at least one of the first link or a second link between the non-AP STA MLD and the AP MLD. Additionally or alternatively, the report is a long range report.

Additionally or alternatively, a second non-AP STA is affiliated with the non-AP STA MLD. Additionally or alternatively, the second non-AP STA transmits over the second link.

Additionally or alternatively, the non-AP STA MLD enables long-range UL transmission to the AP MLD. Additionally or alternatively, the non-AP STA MLD disables long-range UL transmission to the AP MLD.

Additionally or alternatively, the non-AP STA MLD enables long-range UL transmission based on an enablement determination by the non-AP STA MLD. Additionally or alternatively, the non-AP STA MLD UL transmission enablement determination is based on measurements of the first link.

Additionally or alternatively, the non-AP STA MLD disables long-range UL transmission based on an enablement determination by the non-AP STA MLD. Additionally or alternatively, the non-AP STA MLD UL transmission disablement determination is based on measurements of the first link.

Additionally or alternatively, the non-AP STA MLD enables long-range DL transmission from the AP MLD. Additionally or alternatively, the non-AP STA MLD disables long-range DL transmission from the AP MLD.

Additionally or alternatively, the non-AP STA MLD enables long-range DL transmission based on an enablement determination by the non-AP STA MLD. Additionally or alternatively, the non-AP STA MLD DL transmission enablement determination is based on measurements of the first link.

Additionally or alternatively, the non-AP STA MLD disables long-range DL transmission based on an enablement determination by the non-AP STA MLD. Additionally or alternatively, the non-AP STA MLD DL transmission disablement determination is based on measurements of the first link.

Additionally or alternatively, the first non-AP STA transmits, to the first AP STA, indication information indicating the enablement of UL transmission. Additionally or alternatively, the first non-AP STA transmits the indication information indicating the enablement of UL transmission in the report. Additionally or alternatively, the first non-AP STA transmits the indication information indicating the enablement of UL transmission in another frame.

Additionally or alternatively, the first non-AP STA transmits, to the first AP STA, indication information indicating the disablement of UL transmission. Additionally or alternatively, the first non-AP STA transmits the indication information indicating the disablement of UL transmission in the report. Additionally or alternatively, the first non-AP STA transmits the indication information indicating the disablement of UL transmission in another frame.

Additionally or alternatively, the second non-AP STA transmits long-range UL transmissions. Additionally or alternatively, the second non-AP STA transmits a transport block (TB) physical layer (PHY) protocol data unit (PPDU) using a distributed resource unit (DRU) allocation. Additionally or alternatively, the non-AP STA MLD associates with the AP STA MLD based on receipt of the ML probe response frame.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example multi-link device (MLD);

FIG. 3 is a system diagram illustrating an example of long range discovery with multi-link operation (MLO);

FIG. 4 is a signaling diagram illustrating exemplary discovery and association procedures for long range MLDs; and

FIG. 5 is a flowchart diagram illustrating an example of a long range discovery procedure with long range MLDs.

### DETAILED DESCRIPTION

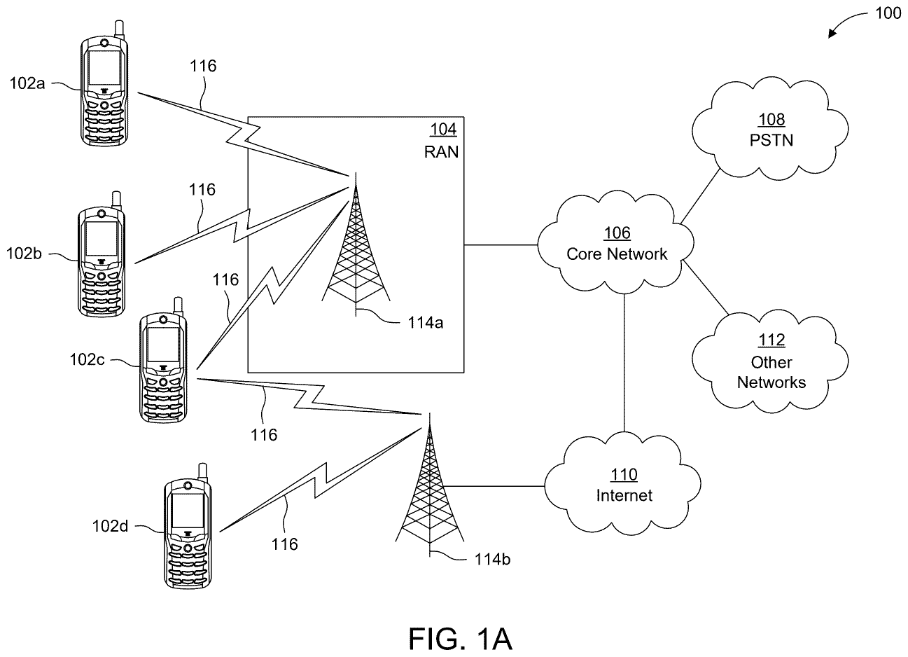

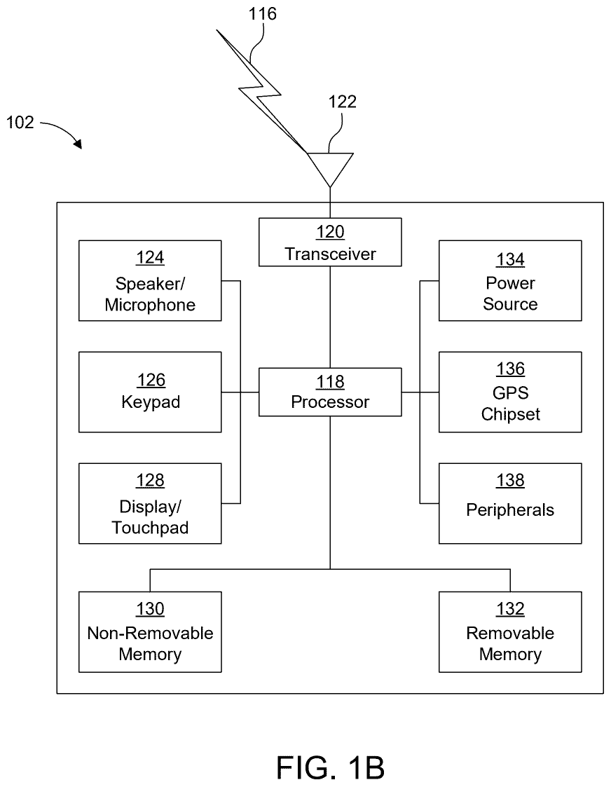

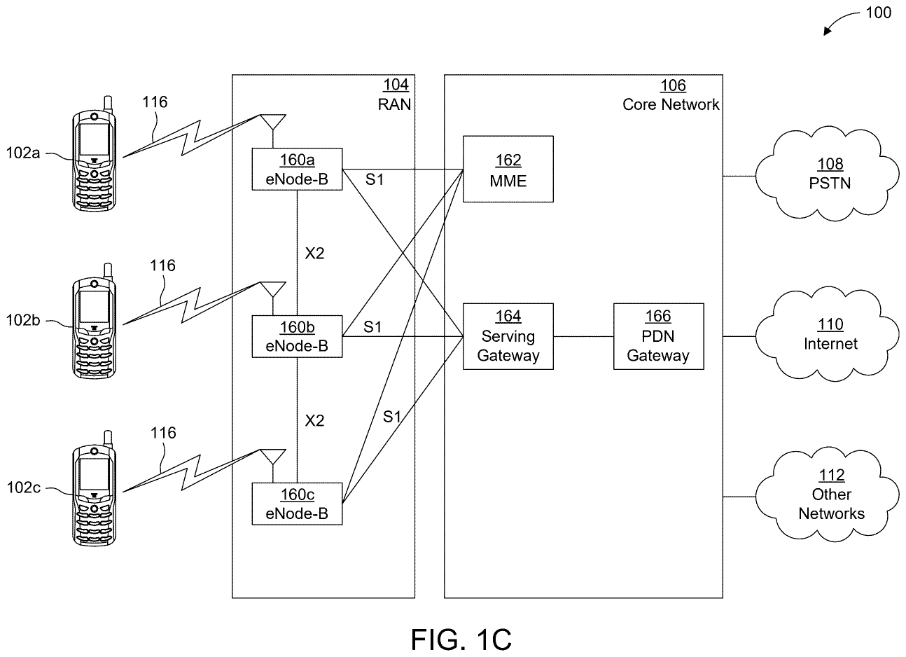

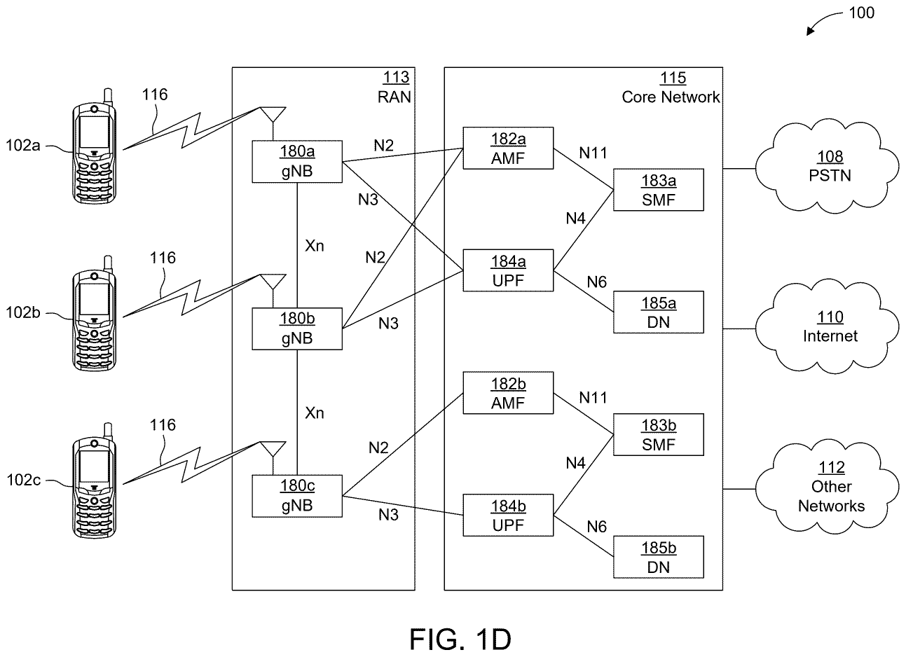

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

WLAN systems which support multiple channels, and channel widths, such as 802.11n, 802.11ac, 802.11af, 802.11ah, and 802.11be, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g., MTC type devices) that only support a 1 MHz mode even if the AP, and other STAs in the BSS, may support a 2 MHz, 4 MHz, 8 MHz, 16 MHz, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

The 802.11 medium access control (MAC) layer is responsible for managing access to the wireless medium and creating the frames that are transmitted. The data handed down to the 802.11 MAC layer from a higher layer is a MAC Service Data Unit (MSDU). The MAC layer takes the MSDU and adds a MAC header and frame check sequence (FCS) to create a MAC Protocol Data Unit (MPDU). Frames may be aggregated and/or fractioned in the MAC layer. An A-MSDU is an aggregated MSDU and an A-MPDU is an aggregated MPDU.

In the MAC layer, there are three types of MPDUs. Data frames carry data passing from a higher layer to the Physical (PHY) layer. Management frames are used for network management. Control frames are used for medium access control.

The 802.11 PHY layer is composed of two sublayers, a physical layer convergence procedure (PLCP) sublayer and a physical medium dependent (PMD) sublayer. The PLCP prepares the packet for transmission by taking the frame from the MAC sublayer and creating a PLCP Protocol Data Unit (PPDU). The PMD sublayer then modulates and transmits the data as bits.

When the MPDU is handed down to the physical layer it is then referred to as a PLCP Service Data Unit (PSDU). A PPDU is composed of a PLCP preamble and header, and a PSDU. Different 802.11 amendments may have different PPDU formats, such as non-HT PPDUs (defined before 802.11n), HT PPDUs (defined in 802.11n), VHT PPDUs (defined in 802.11ac), high efficiency (HE) PPDUs (defined in 802.11ax), extremely high throughput (EHT) PPDUs (defined in 802.11be) and Ultra High Reliability (UHR) PPDUs (defined in 802.11bn).

A multi-link device (MLD) and multi-link operation (MLO) are introduced in 802.11be.

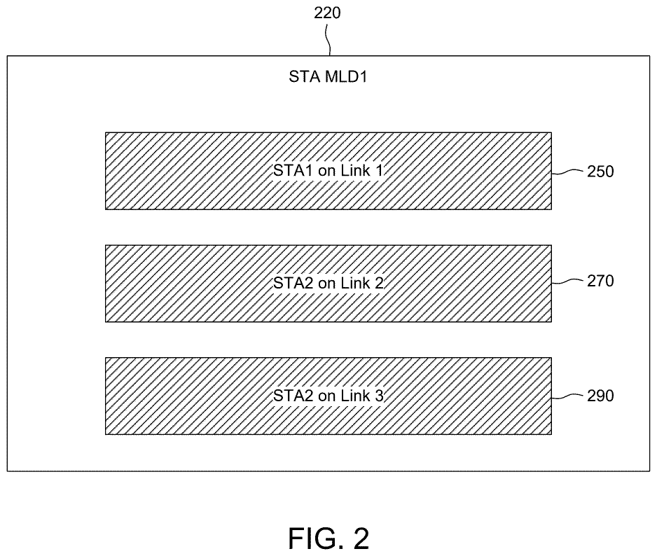

FIG. 2 a system diagram illustrating an example MLD. As shown in FIG. 2, three STAs are affiliated with a STA MLD 220, also shown as, STA MLD 1. STA1 250 affiliated with STA MLD 220 is operating on link 1. Further, STA2 270 affiliated with STA MLD 220 is operating on link 2. Also, STA3 290 affiliated with STA MLD 220 is operating on link 3. Each link represents a physically non-overlapping frequency channel. For example, link 1 may be a channel on 2.4 GHz. Both link 2 and link 3 may be two separated channels on 5 GHZ. In an example, STA MLD 220 may be similar to WTRU 102.

For MLO, one or more links are used for communication between an AP MLD and a non-AP MLDs after the MLD setup.

The IEEE 802.11 UHR, or 802.11bn, Study Group was formed as the next major revision to the IEEE 802.11 standards following 802.11be (HEW), which is noted above. UHR explores the possibility of improving reliability, supporting further reduced low latency traffic, further increasing peak throughput, improving power saving capabilities, and improving efficiency of the IEEE 802.11 network. Work has begun on a major amendment, IEEE 802.11bn, for a next generation wireless LAN, that applies to carrier frequency operation between 1 GHz and 7.250 GHz.

Two new features are added to 802.11bn to support long range transmissions. One new feature is the enhanced long range (ELR) PPDU. The ELR PPDUs can be used to overcome the link budget imbalance between downlink and uplink. The ELR PPDU can be used in both downlink and uplink in the 2.4 GHz band. It can be used only in uplink transmission in the 5 GHz and 6 GHz bands. The bandwidth of the ELR PPDU is 20 MHz and one spatial stream is used for ELR transmissions. The second new feature is the distributed tone resource unit (DRU). DRU is defined to overcome power spectral density (PSD) limitations and boost the transmit power by spreading the allocated tones in a distribution bandwidth. 802.11bn supports DRU for trigger-based (TB) PPDU transmissions.

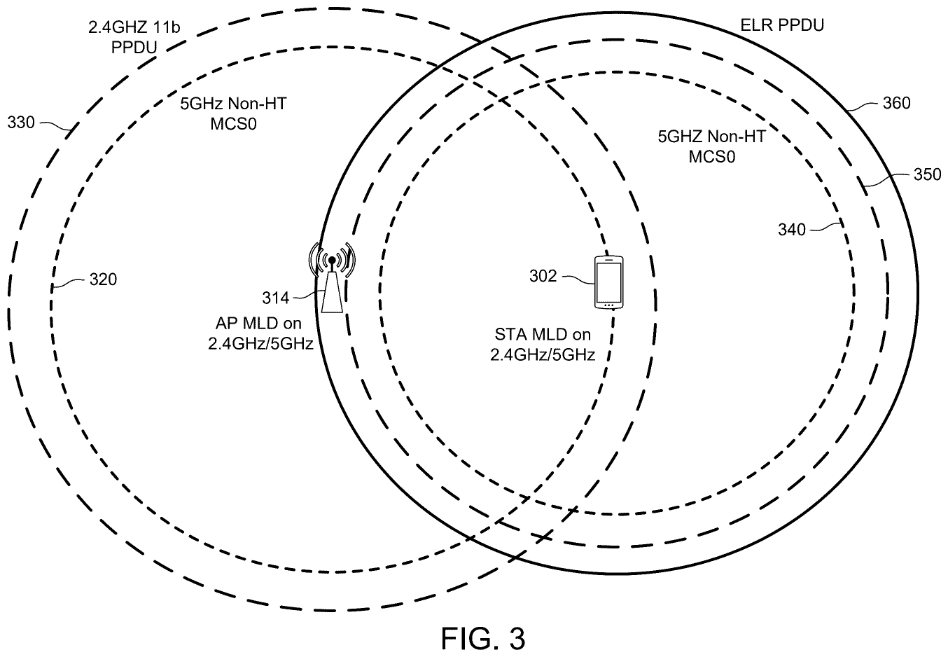

FIG. 3 is a system diagram illustrating an example of long range discovery with MLO. FIG. 3 illustrates a scenario where an AP MLD 314 has two affiliated APs. The AP MLD 314 may be similar to one or both of base stations 114a, 114b. AP1 affiliated the AP MLD 314 operates on a 2.4 GHz link, and AP2 affiliated the AP MLD 314 operates on a 5 GHz link. Meanwhile, a non-AP STA MLD 302 also has two affiliated STAs. The non-AP STA MLD 302 may be similar to WTRU 102. STA1 affiliated the STA MLD 302 operates on a 2.4 GHz link, and STA2 affiliated the STA MLD 302 operates on a 5 GHz link.

The transmit power of the AP 314 is larger than the transmit power of the STA 302. Further, the coverage range of 5 GHz link is smaller than that of 2.4 GHz in both the AP 314 and the STA 302. A circle 320 illustrates the coverage range of 5 GHz link of the AP 314 and circle 340 illustrates the coverage range of 5 GHz link of the STA 302. In an example, 5 GHz links may be used for HT communication. Additionally or alternatively, the 5 GHz links may be used for modulation and coding scheme (MSC) 0 (MSC0). Further, a circle 330 illustrates the coverage range of 2.4 GHz link of the AP 314 and circle 350 illustrates the coverage range of 2.4 GHz link of the STA 302. The STA MLD 302 may be located at the BSS edge.

The STA2 on the 5 GHz link may be out of the range of the AP2. The STA1 on the 2.4 GHz link may be able to detect a DL Beacon frame carried by a legacy PPDU (such as a PPDU defined in 802.11b) from AP1, but a UL transmission of the STA1 may not be decoded successfully by the AP1 due to the lower transmit power of the STA MLD 302 comparing to the AP 314. However, the STA MLD 302 may be a UHR STA MLD which is cable of long-range transmission, for example, an ELR PPDU. The STA1 may use an ELR PPDU on a 2.4 GHz link to carry its Probe Request and Association Request frames to establish association between the MLDs in both links. A circle 360 illustrates the coverage range of an ELR PPDU on the 2.4 GHz link of the STA 302.

As explained in embodiments and examples provided herein, after association, the non-AP STAs may report a received strength signal indicator (RSSI)/Pathloss measurement to the AP. For example, the STA MLD 302 may report an RSSI)/Pathloss measurement to the AP 314.

Further, the non-AP STAs may enable/disable long range transmissions, in embodiments and examples provided herein. Additionally or alternatively, the -AP STAs may suggest enabling/disabling long range transmissions and AP may determine to allow/disallow long range transmissions for the non-AP STA, in embodiments and examples provided herein.

Example solutions provided herein include a general action frame format. Action frames are management frame with special format. The MAC frame body of an action frame has a general format as shown in Table 1, below. The Category field describes the action frame type, such as HE actions frame, EHT action frame, and so forth. The second field, in other words, xxx Action field, may depend on the Category. For example, if the Category field indicates an EHT action frame, the second field is an EHT Action field, which indicates the finer type of the action frame under the EHT category. If a new category is defined, the second filed, as the Action field, may be changed accordingly. For example, if the first field is defined as a UHR category, the second field may indicate a UHR Action field. Likewise, if the first field is defined as a Protected UHR category, the second field may indicate a Protected UHR Action field. There may be one or more fields followed which may carry the detailed information for the action frame.

TABLE 1
Action Frame Format

| Order | Meaning |
|---|---|
| 1 | Category |
| 2 | xxx Action |
| . . . | . . . |

With UHR amendment, a protected UHR action frame category may be defined as shown in Table 2, below, where the Category field may indicate a protected UHR action frame. The Protected UHR Action field right after the Category field may differentiate the detailed protected UHR action frames.

TABLE 2
action frame format with protected UHR category

| Order | Meaning |
|---|---|
| 1 | Category |
| 2 | Protected UHR Action |
| . . . | . . . |

A UHR action frame category may be defined as shown in Table 3, below, where the Category field may indicate a UHR action frame. The UHR Action field right after the Category field may differentiate the detailed UHR action frames.

TABLE 3
action frame format with UHR category

| Order | Meaning |
|---|---|
| 1 | Category |
| 2 | UHR Action |
| . . . | . . . |

A Public action frame is an action frame with the Category field may indicate a Public Action frame. The Public Action field right after the Category field may differentiate the detailed Public Action frames.

A physical layer (PHY) protocol data unit (PPDU) may be used in embodiments and examples provided herein. Further, a non-high-throughput (HT) PPDU, which is transmitted using a defined PPDU format, may be used in embodiments and examples provided herein. Moreover, a non-HT duplicate PPDU, where a single data frame is duplicated and sent across multiple 20 MHz channels simultaneously, may be used in embodiments and examples provided herein.

Example solutions provided herein include multi-link operation with long range support. Examples of Basic Service Set (BSS) discovery and association are provided here. Given the same transmit power and data rate, the coverage range of a STA depends on the operation frequency band. Normally, the STA operating on a lower frequency band (e.g., 2.4 GHZ) may have larger coverage range than that operating on a higher frequency band (e.g., 5 GHZ or 6 GHZ).

IEEE 802.11be introduced multi-link operation (MLO) which allows a multi-link device (MLD) operating on multiple links. On each link, there is a STA affiliated with the MLD. BSS discovery and association procedure may be performed at the MLD level. This means a non-AP STA MLD can establish an association with an AP MLD through one link and the established association may apply to multiple links between the two MLDs.

With the help of MLO, MLD STAs which are located far away from any AP MLDs may consider performing discovery and association through the lower frequency link(s). During the discovery and association procedure, ELR and DRU may help the non-AP STA MLDs to reach the AP MLD. As shown above, FIG. 3 provide examples of an imbalanced coverage range of AP and non-AP STA with difference links and different type of PPDUs. Related exemplary mechanisms and procedure are provided below.

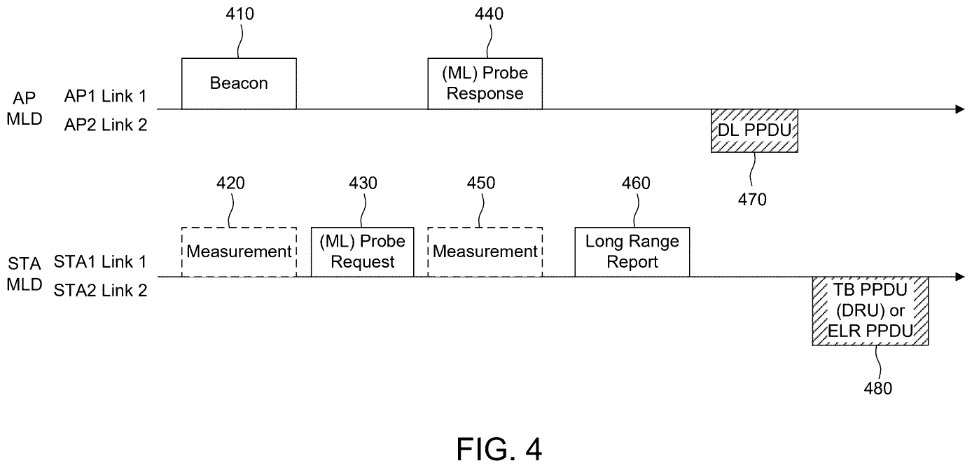

FIG. 4 a signaling diagram illustrating exemplary discovery and association procedures for long range MLDs. An example in FIG. 4 includes an AP MLD and a non-AP STA MLD. AP1 and AP2 are affiliated with the AP MLD and operating on link 1 and link 2 respectively. STA1 and STA2 are affiliated with the STA MLD and operating on link 1 and link 2 respectively. FIG. 4 includes multiple procedures. The first part is the ML discovery and probe request/response procedure. The second part is the ML long range measurement report procedure. The details of ML discovery and probe request/response procedure are given below.

AP1 may transmit a Beacon frame 410 on Link 1. The Beacon frame 410 may carry a multi-link (ML) information element (IE) which may indicate that AP2 is affiliated with the same AP MLD that AP1 is affiliated with, and operates on link 2. To reduce the size of the Beacon frame 410, a partial profile of AP2 may be included in the ML IE. As used herein, a complete profile of AP2 consists of elements and fields that need to be carried by the Beacon frames transmitted by AP2 on link 2. A partial profile of AP2 consists of selected elements and fields that need to be carried by the Beacon frames transmitted by AP2 on link 2.

Additionally or alternatively, the Beacon frame 410 may be transmitted with an 802.11b PPDU. Additionally or alternatively, the Beacon frame 410 may indicate that the AP supports MLD. Additionally or alternatively, the Beacon frame 410 may indicate that the AP supports both Link 1 and Link 2. Additionally or alternatively, the Beacon frame 410 may indicate that the AP MLD supports long range transmission, such as ELR, DRU or both on Link 1, Link 2 or both.

In an example method, in AP2's profile, it may indicate that AP2 may be capable of receiving and transmitting ELR PPDUs, and/or AP2 be capable of receiving using a DRU in a TB PPDU. Further, in an example method, in AP2's profile, it may indicate that AP2 may be capable of receiving Probe Request frames carried in ELR PPDUs. In one method, in AP2's profile, it may indicate that AP2 may be capable of transmitting Probe Response frames carried in ELR PPDUS.

Also, in an example method, AP1 may indicate transmit power of the Beacon frame on link 1. A non-AP STA may use this information and one or more measured RSSI values based on the Beacon frame to derive the pathloss between the AP and the non-AP STA on link 1.

Additionally, in an example method, AP1 may indicate that it may be capable of receiving Probe Request frames carried in ELR PPDUs. In one example method, AP1 may indicate that it may be capable of transmitting Probe Response frames carried in ELR PPDUs.

The STA1 operating on link 1 may receive the Beacon frame 410 transmitted by AP1 on link 1. The STA MLD may determine to associate with the AP MLD. STA1 may transmit a multi-link Probe Request frame 430, which includes an ML IE.

In one example method, STA1 may request the long-range related information of AP2 in either complete or partial profile of AP2 by including a Request element, or an Extended Request element or both in the frame body of the multi-link Probe Request frame and/or in a Per-STA Profile sub-element in a Probe Request Multi-Link element in the multi-link Probe Request frame where Complete Profile Requested subfield may be set to 0 or 1 respectively.

In one example method, long range transmission related information may be carried in an element or field which may need to be included in the multi-link Probe Response frame by default. In one example method, long range transmission related information may be carried in an element or field which may not need to be included in the multi-link Probe Response frame by default. STA1 may request AP1 to carry them in the multi-link Probe Response frame.

In one example method, STA1 may indicate whether it supports ELR transmissions, DRU transmissions, or both transmissions. In one example method, STA1 may indicate whether STA2 affiliated with the same STA MLD as STA1 supports ELR and/or DRU transmissions. In one example method, the Probe Request frame may be carried in an ELR PPDU.

On reception of the ML Probe Request frame from STA1, AP1 may respond with an ML Probe Response frame 440. In one example method, AP1 may indicate whether it supports ELR and/or DRU on link 1.

In one example method, the ML Probe Response frame 440 may carry an ML IE which includes a complete profile of AP2 on link 2. In one example method, the ML IE may include the information whether AP2 supports ELR, supports DRU, or supports both on link 2. Moreover, the STA MLD and AP MLD may continue association procedure based on the exchanged information.

If the STA MLD may successfully associate with AP MLD, the STA MLD may continue to monitor the Beacon frames transmitted periodically on link 1, similar to Beacon frame 410. The STA MLD may perform measurements, such as measurements 420, 450, based on Beacon frames, sounding frames and/or other type of frames on link 1.

Further, the STA1 may take measurements based on one or more frames or PPDUs transmitted by AP1 on link 1. In one example method, STA1 may monitor the Beacon transmissions from AP1 and take measurement(s) related to the received power, such as RSSI, estimated pathloss, signal-to-noise ratio (SNR), and the like.

In one example method, the AP1 may transmit one or more sounding frames or PPDUs, for example, a null data packet (NDP) with a transmit power known to either AP1 or STA1, or both. The STA1 may monitor the sounding transmissions from AP1 and take measurement(s) related to the received power, such as RSSI, estimated pathloss, SNR, and the like.

In one example method, the AP1 may transmit one or more frames with a transmit power known to either AP1 or STA1, or both. The STA1 may monitor the sounding transmissions from AP1 and take measurement(s) related to the received power, such as RSSI, estimated pathloss, SNR and the like.

The STA1 may feedback the one or more measurements, such as measurements 420, 450, with other possible parameters to AP1 by transmit a Long-Range Report frame 460. If the one or more measurements indicate that STA1's receive signal is not strong, the STA may suggest using long range features for its uplink and/or downlink transmission. For example, the measurement is out of a predefined range, when, for example, the estimated pathloss value is greater than a threshold, the measured RSSI/SNR is less than a threshold, and so forth. Accordingly, the STA1 may indicate information to the AP1 using one or more of the below example methods.

In an example method, the STA1 may indicate it may need to use long range transmissions such as ELR transmissions or DRU transmissions in the uplink to reach the AP. This indication may be for the current link (e.g., link 1) and/or another links (e.g., link 2).

In an example method, the STA1 may indicate it may prefer ELR transmissions from the AP in the downlink. This indication may be for the current link (e.g., link 1) and/or another links (e.g., link 2).

In an example method, the STA1 may include the measurement (e.g., Pathloss, RSSI, SNR, and so forth). The STA1 may indicate the link on which the measurement is taken. Additionally or alternatively, the STA1 may indicate the frame/PPDU (e.g., Beacon frame carried in non-HT PPDU) on which the measurement is taken. With this information, the receiving AP may know the transmit power and mode of the frame/PPDU on which the measurement is taken.

In an example method, the feedback may be carried in an Action frame, a management frame, or a control frame. In an example method, the feedback may be carried in a MAC header or PHY header, and aggregated with other frames or transmissions.

In an example method, the feedback may be cross-link feedback or feedback valid for multiple links. For example, a link identity (ID), or a link indication bitmap may be carried to indicate one or more links. In an example method, the feedback may be a per-link feedback. In this case, all the parameters carried may be applied to the current link.

In an example method, the non-AP STAs/MLDs may report their measurement and make long-range transmission suggestions in the Long-Range Report frame 460. Additionally or alternatively, the non-AP STAs/MLDs may request long rang transmission, such as ELR transmissions, DRU transmissions, or both, from the AP MLD. The AP or AP MLD may determine to enable/disable long range transmission for each non-AP STA/MLD based on the report and BSS conditions. The AP may transmit a Long-Range Notification frame to a non-AP STA on one link to indicate if the STA or STAs affiliated with the STA MLD may be allowed to use long-range transmissions on the link, on several links, or on all active links.

The AP MLD and the STA MLD may use the suggested feature to communicate on the corresponding link(s). In an example, the AP2 may transmit a DL PPDU 470 to STA2 on link 2. For example, AP2 may transmit an ELR PPDU to STA2. STA2 may respond with an ELR PPDU 480. Or AP 2 may transmit a PPDU (e.g., ELR PPDU) which carries a Trigger frame to allocate a DRU to STA2. STA2 may transmit a TB PPDU 480 using the DRU allocated by AP2.

Also, the long-range transmissions mentioned in the example above may be replaced by ELR transmission, or DRU transmissions, or ELR and DRU transmissions, and the above examples would still apply. Further, examples provided herein use the Long Range Report frame as an example to carry long range related measurements, and enablement/disablement signals or suggestions. The information may be carried by other frames or element, and the above examples would still apply. Moreover, the intra-link and/or cross-link measurements such as RSSI, Pathloss, and so forth, may be used for other purpose such as seamless roaming, coordinated spatial reuse, and so forth, and the above examples would still apply.

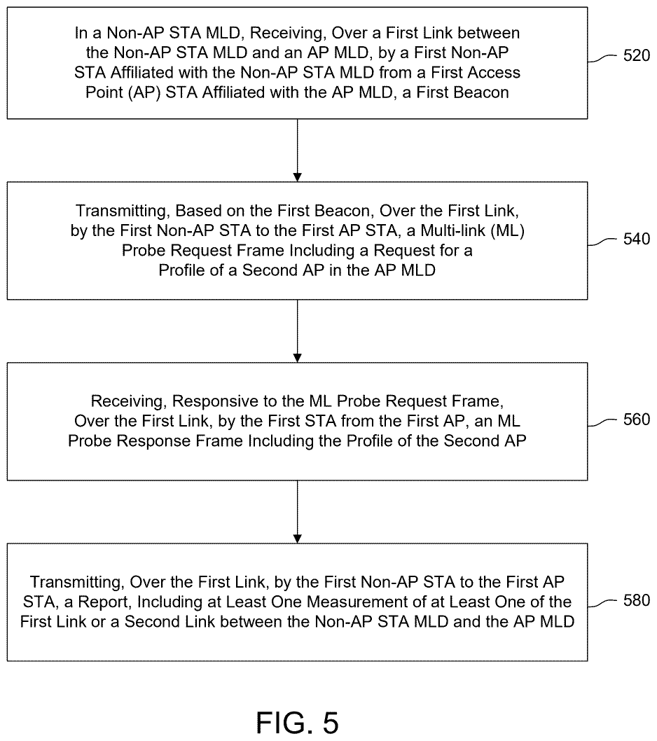

FIG. 5 is a flowchart diagram illustrating an example of a long range discovery procedure with long range MLDs. In an example in FIG. 5, an AP MLD and a non-AP STA MLD may use a first link and a second link. A first non-AP STA is affiliated with the non-AP STA MLD, and a first AP STA is affiliated with the AP MLD. The first AP STA transmits, and the first non-AP STA receives, a first beacon 520 over the first link.

In an example, the first beacon may include indication information indicating transmit power of the first beacon on link 1. Additionally or alternatively, the first beacon may include an ML IE.

Further, the first non-AP STA transmits, based on the first beacon, over the first link, an ML probe request frame including a request for a profile of a second AP STA affiliated with the AP MLD 540. Additionally or alternatively, the requested profile may include long range related information of the second AP STA. Additionally or alternatively, the ML probe request frame further includes an ML element. Additionally or alternatively, the ML element is an ML IE. The ML probe request is transmitted to, and received by, the first AP STA. Also, the first non-AP STA receives, responsive to the ML probe request frame, over the first link, an ML probe response frame including the profile of the second AP STA 560. Additionally or alternatively, the profile may include long range related information. The ML probe response frame is received from, and transmitted by, the first AP STA.

Moreover, the first non-AP STA transmits, over the first link, a report, including an ML report with at least one measurement of at least one of the first link or the second link 580. Additionally or alternatively, the first non-AP STA transmits the report based on the ML probe response frame. Additionally or alternatively, the report includes an ML report. Additionally or alternatively, the ML report includes the at least one measurement of at least one of the first link or a second link between the non-AP STA MLD and the AP MLD. Additionally or alternatively, the report may be a long range report.

Additionally or alternatively, a second non-AP STA is affiliated with the non-AP STA MLD. Additionally or alternatively, the second non-AP STA transmits over the second link.

Additionally or alternatively, the non-AP STA MLD enables long-range UL transmission to the AP MLD. Additionally or alternatively, the non-AP STA MLD disables long-range UL transmission to the AP MLD.

Additionally or alternatively, the non-AP STA MLD enables long-range UL transmission based on an enablement determination by the non-AP STA MLD. Additionally or alternatively, the non-AP STA MLD UL transmission enablement determination is based on measurements of the first link. Additionally or alternatively, the non-AP STA MLD disables long-range UL transmission based on an enablement determination by the non-AP STA MLD. Additionally or alternatively, the non-AP STA MLD UL transmission disablement determination is based on measurements of the first link.

Additionally or alternatively, the non-AP STA MLD enables long-range DL transmission from the AP MLD. Additionally or alternatively, the non-AP STA MLD disables long-range DL transmission from the AP MLD.

Additionally or alternatively, the non-AP STA MLD enables long-range DL transmission based on an enablement determination by the non-AP STA MLD. Additionally or alternatively, the non-AP STA MLD DL transmission enablement determination is based on measurements of the first link.

Additionally or alternatively, the non-AP STA MLD disables long-range DL transmission based on an enablement determination by the non-AP STA MLD. Additionally or alternatively, the non-AP STA MLD DL transmission disablement determination is based on measurements of the first link.

Additionally or alternatively, the first non-AP STA transmits, to the first AP STA, indication information indicating the enablement of UL transmission. Additionally or alternatively, the first non-AP STA transmits the indication information indicating the enablement of UL transmission in the report. Additionally or alternatively, the first non-AP STA transmits the indication information indicating the enablement of UL transmission in another frame.

Additionally or alternatively, the first non-AP STA transmits, to the first AP STA, indication information indicating the disablement of UL transmission. Additionally or alternatively, the first non-AP STA transmits the indication information indicating the disablement of UL transmission in the report. Additionally or alternatively, the first non-AP STA transmits the indication information indicating the disablement of UL transmission in another frame

Additionally or alternatively, the second non-AP STA transmits long-range UL transmissions. Additionally or alternatively, the second non-AP STA transmits a transport block (TB) physical layer (PHY) protocol data unit (PPDU) using a DRU allocation.

Additionally or alternatively, the non-AP STA MLD associates with the AP STA MLD based on receipt of the ML probe response frame. Additionally or alternatively, the non-AP STA MLD and the AP STA MLD then begin MLO.

In an example method, an AP may enable/disable the long-range transmissions (e.g., ELR PPDUs and/or TB PPDU with DRU allocation) for the BSS or for one or more STAs associated with the AP. This enabling/disabling may be a link level signaling or MLD level signaling. With link level signaling, each AP may enable/disable long range transmissions for the transmitting link or an active link even though the AP may be affiliated with an AP MLD. With MLD level signaling, each AP MLD may enable/disable long range transmission for all the APs affiliated with the AP MLD. The long range enabling/disabling signal may be carried in a UHR operation element or other element and broadcasted by the AP.

In an example method, the non-AP STA may enable/disable long range transmissions by setting a field, for example, a Long-Range Enabling field, to certain value. The field may be carried in the Long-Range Report frame or a Notification frame or other frames transmitted by a non-AP STA. This enabling/disabling may be a link level signaling or MLD level signaling. With MLD level signaling, once this field is set to certain value, all the STAs affiliated with the same MLD should enable (or disable) the long-range transmission. Or the signaling may be related to one or more links established between the MLD and thus the enablement/disablement signaling may be applied to one or more links indicated. With link level signaling, each non-AP STA affiliated with a non-AP MLD may determine to enable/disable long-range transmission independently for the link on which the transmission occurs. If the signaling is in the link level, the Long-Range Enabling field may be carried in a cross-link element/frame. For example, the field may be a bitmap where each bit may indicate a link. Or the Long-Range Enabling field may work together with a Link ID. Or the Long-Range Enabling field may carry enabling/disabling information for a single link, for example, the current link.

In an example method, a non-AP STA may enable/disable the long-range transmissions (e.g., ELR PPDUs and/or TB PPDU with DRU allocation) for itself. In an example method, the long range transmission enabling/disabling is carried in a Long Range Report frame or a Mode Change Notification frame.

In an example method, an AP may determine whether it allows a non-AP STA to transmit and receive using long range transmissions. Long range transmissions have a larger coverage range in the cost of lower date rates. The AP may like to control and limit the use of long range transmission in the BSS. For example, a non-AP STA may suggest enable/disabling the long-range transmission and/or provide RSSI or pathloss or other type of channel quality measurement for the AP to determine whether it is allowed to use long-range transmissions. For example, the non-AP STA may transmit a Long Range Report frame or a Mode Notification frame or other type of frame to suggest enabling/disabling long range transmission. On reception of the frame, the AP main respond a Long Range Report frame or Mode Notification frame or other type of frame to indicate whether the AP enables/disables long range transmission schemes for the non-AP STA.

Its associated AP may not expect the non-AP STA to transmit ELR PPDU in uplink if ELR PPDU is disabled by the non-AP STA. The AP may not transmit to the non-AP STA using ELR PPDU in downlink if ELR PPDU is disabled by the non-AP STA. The AP may not assign DRU to the non-AP STA in any trigger frame if DRU is disabled by the non-AP STA. In an example method, the enablement and disablement mentioned above may be a MLD level concept which applies to all affiliated STAs in the STA MLD. A non-AP STA may not expect its associated AP to transmit ELR PPDU in downlink if ELR PPDU is disabled by either the AP or the non-AP STA. A non-AP STA may not transmit an ELR PPDU to its associated AP in uplink if ELR PPDU is disabled by either the AP or the non-AP STA. A non-AP STA may not expect its associated AP to assign a DRU in a trigger frame if DRU PPDU is disabled by either the AP or the non-AP STA.

In an example method, the Long Range Report frame may be an UHR (Protected) Action frame. The action format is shown in Table 2 or Table 3, above. The Category is defined in examples shown herein above. The (Protected) UHR Action field is given in Table 4, below. When the value is set to x, it indicates the action frame is a Long Range Report frame. For example, x could be 1, or 2 or another number.

TABLE 4
(Protected) UHR Action field

| Value | Meaning |
|---|---|
| . . . | . . . |
| x | Long Range Report |
| . . . | . . . |

TABLE 5
Long Range Report frame format

| Order | Information |
|---|---|
| 1 | Category |
| 2 | (Protected) UHR Action |
| 3 | Dialog Token |
| 4 | Link ID |
| 5 | Long Range Report |

The Long-Range Report frame format is shown in Table 5, above. The Dialog Token field is a set to a nonzero value chosen by the non-AP STA to identify the Long Range Report transaction. The Link ID field may indicate the report is for the link identified by the Link ID field. In an example method, this Link ID field is omitted, and the cross-link information may be carried in the Long Range Report field directly. In an example, the report may be for the current link and link related information may be omitted.

An example Long Range Report field format is shown in Table 6, below. The ELR Enabled field indicates if ELR is enabled/disabled for the link identified by the Link ID, the current link or the MLD. The DRU Enabled field may indicate if DRU is enabled/disabled the link identified by the Link ID, the current link or the MLD. The RSSI Measurement field may carry the RSSI measurement for the link identified by the Link ID, the current link or the MLD. The Pathloss Measurement field may carry the pathloss measurement for the link identified by the Link ID, the current link or the MLD.

TABLE 6
Long Range Report field format I

| | | | |
|---|---|---|---|
| ELR | DRU | RSSI | Pathloss |
| Enabled | Enabled | Measurement | Measurement |

An additional or alternative example Long Range Report field format is shown in Table 7, below. The last field, the Number of Concurrent Links field, may indicate the number of concurrent active links enabled by the STA MLD. To simplify the details used, examples herein may refer the value set to this field as N. The ELR Enabled field may be a bitmap with size N and each bit indicates if ELR is enabled/disabled for the corresponding link. The DRU Enabled field may be a bitmap with size N and each bit indicates if DRU is enabled/disabled for the corresponding. The RSSI Measurement field may have N subfields where each subfield may carry the RSSI measurement for the corresponding link. The Pathloss Measurement field have N subfields where each subfield may carry the pathloss measurement for the corresponding link.

TABLE 7
Long Range Report field format II

| | | | | |
|---|---|---|---|---|
| ELR | DRU | RSSI | Pathloss | Number of |
| Enabled | Enabled | Measurement | Measurement | Concurrent |
| | | | | Links |

In an example method, a notification frame may be defined to carry enablement/disablement information for multiple modes, including long range transmission. The Notification frame may be referred as a Mode Change Notification frame. The Mode Change Notification frame may be a (Protected) UHR Action frame with format shown in in Table 2 or Table 3. The Category is defined in examples provided herein above. The (Protected) UHR Action field is given in Table 8, below. When the value is set to x, it indicates the action frame is a Mode Change Notification frame, in an example.

TABLE 8
UHR Action field II

| Value | Meaning |
|---|---|
| . . . | . . . |
| x | Mode Change Notification |
| . . . | . . . |

An example Mode Change Notification Action frame format is shown in Table 9, below.

TABLE 9
Mode Change Notification Action frame format

| Order | Information |
|---|---|
| 1 | Category |
| 2 | (Protected) UHR Action |
| 3 | Dialog Token |
| 4 | Mode Change Notification |

The Mode Change Notification field format is shown in Table 10, below. This notification field may include all possible modes which may be enabled/disabled by a non-AP STA and newly introduced to 802.11bn. Each field in Table 10 indicates whether the corresponding feature mode is enabled or disabled.

Accordingly, one or more of the following examples apply to Table 10. ELR Enabled indicates if ELR PPDU is enabled. DRU Enabled indicates if DRU allocation is enabled. NPCA Enabled indicates if non-primary channel access is enabled. DSO Enabled indicates if dynamic subchannel operation is enabled. DUO Enabled indicates if dynamic unavailability operation is enabled. DPS Enabled indicates if dynamic power saving is enabled. Co-TDMA Enabled indicates if coordinated TDMA is enabled. Co-BF Enabled indicates if coordinated beamforming is enabled. Co-SR Enabled indicates if coordinated spatial reuse is enabled. Co-RTWT Enabled indicates if coordinated restricted target time wakeup operation is enabled.

TABLE 10
Mode Change Notification field format

| | | | | |
|---|---|---|---|---|
| ELR | DRU | NPCA | DSO | DUO |
| Enabled | Enabled | Enabled | Enabled | Enabled |
| DPS | Co-TDMA | Co-BF | Co-SR | Co-RTWT |
| Enabled | Enabled | Enabled | Enabled | Enabled |

In the embodiments and example provided herein above, example rules regarding the use of ELR and DRU may apply, such as the following. In 2.4 GHZ, 5 GHZ, and 6 GHZ, (Multi-link) Probe Request frames and (Re) Association Request frames may be carried in ELR PPDUs and/or TB PPDUs with DRU allocation. In 2.4 GHZ, (Multi-link) Probe Response frames and (Re) Association Response frames may be carried in ELR PPDUs and/or TB PPDUs with DRU allocation. In 2.4 GHZ, 5 GHZ, and 6 GHZ, Control frames, such as MU-RTS, RTS, CTS, BSRP, BSRP GI3, Multi-STA BA, Trigger frame, BA, ACK, NDPA, Control Wrapper frame transmitted by a non-AP STA, may be carried in ELR PPDUs and/or TB PPDUs with DRU allocation.

In 2.4 GHZ, Control frames, such as MU-RTS, RTS, CTS, BSRP, BSRP GI3, Multi-STA BA, Trigger, BA, ACK, NDPA, Control Wrapper frame transmitted by an AP STA, may be carried in ELR PPDUs and/or TB PPDUs with DRU allocation. Moreover, a Public Action frame may be carried in ELR PPDUs and/or TB PPDUs with DRU allocation.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a non-access point (AP) station (STA) multi-link device (MLD), the method comprising:
receiving, over a first link between the non-AP STA MLD and an AP MLD, by a first non-AP STA affiliated with the non-AP STA MLD from a first access point (AP) STA affiliated with the AP MLD, a first beacon;
transmitting, based on the first beacon, over the first link, by the first non-AP STA to the first AP STA, an multi-link (ML) probe request frame including a request for a profile of a second AP STA affiliated with the AP MLD;
receiving, responsive to the ML probe request frame, over the first link, by the first non-AP STA from the first AP STA, an ML probe response frame including a profile of the second AP STA; and
transmitting, over the first link, by the first non-AP STA to the first AP STA, a report including at least one measurement of at least one of the first link or a second link between the non-AP STA MLD and the AP MLD.

2. The method of claim 1, further comprising:
enabling long range transmission to the AP MLD by the first non-AP STA over the first link, by a second non-AP STA over the second link, or by both; wherein the report includes information indicating enablement of long range transmission to the AP MLD.

3. The method of claim 2, wherein the enablement of long range transmission to the AP MLD is determined by the non-AP STA MLD.

4. The method of claim 3, wherein the determination of the enablement of long range transmission to the AP MLD is based on measurements of the first link by the first non-AP STA.

5. The method of claim 2, further comprising:
receiving, responsive to the report, a distributed resource unit (DRU) allocation; and
transmitting, to the non-AP MLD, one or more transport block (TB) physical layer (PHY) protocol data units (PPDUs) using the DRU allocation.

6. The method of claim 2, further comprising:
associating, based on the ML probe response frame, with the AP MLD.

7. The method of claim 1, further comprising:
disabling long range transmission to the AP MLD by the first non-AP STA over the first link, by a second non-AP STA over the second link, or by both; wherein the report includes information indicating disablement of long range transmission to the AP MLD.

8. The method of claim 7, wherein the disablement of long range transmission to the AP MLD is determined by the non-AP STA MLD.

9. The method of claim 8, wherein the determination of the disablement of long range transmission to the AP MLD is based on measurements of the first link by the first non-AP STA.

10. The method of claim 1, wherein the ML probe request frame further includes an ML element, wherein the report is transmitted based on the ML probe response frame, wherein the report includes an ML report, wherein the ML report includes the at least one measurement of at least one of the first link or a second link between the non-AP STA MLD and the AP MLD, and wherein the report is a long range report.

11. A non-access point (AP) station (STA) multi-link device (MLD) comprising:
a processor; and
a transceiver operatively coupled to the processor; wherein:
the transceiver is configured to receive, over a first link between the non-AP STA MLD and an AP MLD, by a first non-AP STA affiliated with the non-AP STA MLD from a first access point (AP) STA affiliated with the AP MLD, a first beacon;
the transceiver and the processor are configured to transmit, based on the first beacon, over the first link, by the first non-AP STA to the first AP STA, an multi-link (ML) probe request frame including a request for a profile of a second AP STA affiliated with the AP MLD;
the transceiver is configured to receive, responsive to the multi-link (ML) probe request frame, over the first link, by the first non-AP STA from the first AP STA, an ML probe response frame including a profile of the second AP STA; and
the transceiver and the processor are configured to transmit, over the first link, by the first non-AP STA to the first AP STA, a report, including at least one measurement of at least one of the first link or a second link between the non-AP STA MLD and the AP MLD.

12. The non-AP STA MLD of claim 10, wherein the processor is further configured to enable long range transmission to the AP MLD by the first non-AP STA over the first link, by a second non-AP STA over the second link, or by both; wherein the report includes information indicating enablement of long range transmission to the AP MLD.

13. The non-AP STA MLD of claim 12, wherein the enablement of long range transmission to the AP MLD is determined by the non-AP STA MLD.

14. The non-AP STA MLD of claim 13, wherein the determination of the enablement of long range transmission to the AP MLD is based on measurements of the first link by the first non-AP STA.

15. The non-AP STA MLD of claim 12, wherein:
the processor is further configured to receive, responsive to the report, a distributed resource unit (DRU) allocation; and
the transceiver and the processor are configured to transmit, to the non-AP MLD, one or more transport block (TB) physical layer (PHY) protocol data units (PPDUs) using the DRU allocation.

16. The non-AP STA MLD of claim 12, wherein the transceiver and the processor are configured to associate, based on the ML probe response frame, with the AP MLD.

17. The non-AP STA MLD of claim 11, wherein the processor is further configured to disable long range transmission to the AP MLD by the first non-AP STA over the first link, by a second non-AP STA over the second link, or by both; wherein the report includes information indicating disablement of long range transmission to the AP MLD.

18. The non-AP STA MLD of claim 17, wherein the disablement of long range transmission to the AP MLD is determined by the non-AP STA MLD.

19. The non-AP STA MLD of claim 18, wherein the determination of the disablement of long range transmission to the AP MLD is based on measurements of the first link by the first non-AP STA.

20. The non-AP STA MLD of claim 11, wherein the ML probe request frame further includes an ML element, wherein the report is transmitted based on the ML probe response frame, wherein the report includes an ML report, wherein the ML report includes the at least one measurement of at least one of the first link or a second link between the non-AP STA MLD and the AP MLD, and wherein the report is a long range report.
